(19) United States
(12) Patent Application Publication
(10) Pub. No.: US 2002/0073397 A1
(43) Pub. Date: Jun. 13, 2002

(54) Component development supporting system

(75) Inventors: Kazuki Yoshida, Fuchu-Shi (JP); Hisanori Matsuo, Fuchu-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/011,984

(22) Filed: Dec. 11, 2001

(30) Foreign Application Priority Data
Dec. 12, 2000 (JP) 2000-377381

(51) Int. Cl. G06F 9/44

(52) U.S. Cl. 717/104; 717/107

(57) ABSTRACT

There is provided a component development supporting system capable of efficiently developing a component which will form the basis for the development of an application. If the user uses an input/output device 18 to generate a template Session Bean (a process generating part 20), an execution statement part 22 of the process generating part 20 calls a predefined interface to make a request for the generation of an Enterprise Bean instance. In accordance therewith, a Session Bean instance 41 is generated, and a request for the generation of a process model 42 is made to a process model generating part 21. The process model generating part 21 automatically generates a program statement for realizing a process of a component, on the basis of a component definition information 17, and sequentially executes the program statement to generate an executable process model 42 in a memory of a computer. The process model 42 is generated so as to be related to the Session Bean instance 41.

### BACKGROUND OF THE INVENTION

1. Field of the Invention

The present invention generally relates to a component technique for developing an application by connecting reusable components. More specifically, the invention relates to a component development supporting system for developing components which will form the basis for the development of an application.

2. Description of the Related Art

As specifications for developing an application by connecting components, the EJB (Enterprise Java Beans) is known. The EJB provides an environment in which an application is developed by connecting a plurality of components (Enterprise Beans). In such an environment, an application programmer can concentrate on the implementation of a business logic without being conscious of problems on concurrent performance in process, permanence in entity and so forth. Furthermore, the Enterprise Bean used for the EJB is a component capable of being executed on an optional platform that is provided as an EJB server.

It is expected that a three-layer type system configuration, in which a program of a business logic is, like the specifications of the EJB, arranged on an intermediate layer of a server, will widely spread in future as a developed type of the Web-top type application system. It is also expected that the development of an Enterprise Bean, which will form the basis for the development of an application, and the integration of the Enterprise Bean into an intermediate layer will be efficiently carried out without deeply entering into the implementation side of the Enterprise Bean.

Although tools for developing the Enterprise Bean in the EJB begin to come onto the market at present, all of such tools are wizard type tools for automating the preparation of common portions in source codes of the Enterprise Bean, and do not sufficiently support the development of components.

### SUMMARY OF THE INVENTION

It is therefore an object of the present invention to eliminate the aforementioned problems and to provide a component development supporting system, method and program, capable of efficiently developing components which will form the basis for the development of an application.

In order to accomplish the aforementioned and other objects, according to one aspect of the present invention, there is provided a component development supporting system for developing a component, which will form the basis for the development of an application, by connecting a plurality of process elements. The component development supporting system comprises: a process constructing part that models a process of a component by connecting a plurality of process elements and outputs the result of modeling as a component definition information; and a process generating part that generates a component on the basis of the component definition information which is outputted from the process constructing part, wherein the process generating part has (i) a first generating part for generating an executable process model, which includes a plurality of process elements, on the basis of the component definition information, and (ii) a second generating part for generating a session instance for calling the process model which is generated by the first generating part, via a predefined interface.

According to another aspect of the present invention, there is provided a component development supporting method for developing a component, which will form the basis for the development of an application, by connecting a plurality of process elements. The component development supporting method comprises the steps of: modeling a process of a component by connecting a plurality of process elements, to output the result of modeling as a component definition information; generating an executable process model, which includes a plurality of process elements, on the basis of the outputted component definition information; and generating a session instance for calling the generated process model via a predefined interface.

According to a further aspect of the present invention, there is provided a computer-readable recording medium having stored a component development supporting program for developing a component, which will form the basis for the development of an application, by connecting a plurality of process elements. The component development supporting program causes a computer to execute the procedures of: modeling a process of a component by connecting a plurality of process elements, to output the result of modeling as a component definition information; generating an executable process model, which includes a plurality of process elements, on the basis of the outputted component definition information; and generating a session instance for calling the generated process model via a predefined interface.

In the above described component development supporting system, method and program, the plurality of process elements preferably include a plurality of basic process elements in which each of basic processes for realizing a process of the component has been implemented, and a plurality of custom process elements in which each of separate processes related to the basic process element has been implemented. In addition, the plurality of process elements preferably further include a plurality of execution sequence elements for forming an execution route to connect the basic process elements to each other. Moreover, the plurality of process elements are preferably displayed as icons to enable a user to model a process of a component by connecting the icons.

According to the present invention, a process of a component is modeled by connecting process elements (basic process elements, custom process elements and execution sequence elements); and then an executable process model and a session instance for calling the process model via a predefined interface are generated on the basis of the modeling of the process. Therefore, the process of the component can be visually modeled, and the generation and execution of the component can be directly carried out without the need of any additional implementation works for the modeled component. Accordingly, the development of the component, which will form the basis for the development of an application, and the integration of the component into the intermediate layer of the server can be efficiently carried out without deeply entering into the implementation side of the component.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a block diagram showing a preferred embodiment of a component development supporting system according to the present invention;

FIG. 2 is an illustration for explaining a modeling process for a component (Enterprise Bean) in the component development supporting system shown in FIG. 1;

FIG. 3 is a block diagram showing an example of a process model for a component (Enterprise Bean);

FIG. 4 is a block diagram for explaining a process for generating a component (Enterprise Bean instance) in the component development supporting system shown in FIG. 1;

FIG. 5 is a block diagram for explaining a function executing process for a component (Enterprise Bean instance) which is generated by the component development supporting system shown in FIG. 1;

FIG. 6 is a diagram for explaining an example of the flow of a process (approach route) in a process model for a component (Enterprise Bean instance);

FIG. 7 is a diagram for explaining the flow of a process (return route) in a process model for a component (Enterprise Bean instance) shown in FIG. 7; and

FIG. 8 is a block diagram showing an example of a computer system in which a component development supporting program is installed.

### DESCRIPTION OF THE PREFERRED EMBODIMENTS

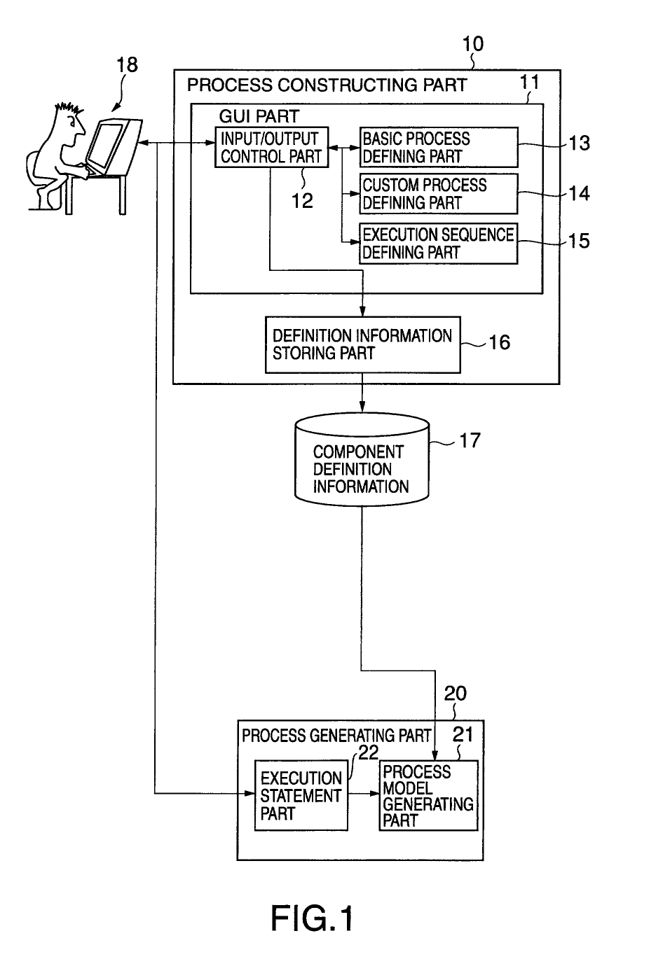

Referring now to the accompanying drawings, particularly to FIGS. 1 to 8, a preferred embodiment of a component development supporting system according to the present invention will be described below. Please note that, in this preferred embodiment, the development of a component (Enterprise Bean) used in the EJB (Enterprise Java Beans) will be described as an example.

As shown in FIG. 1, the component development supporting system in this embodiment comprises a process constructing part 10 for modeling a process of a component by connecting a plurality of process elements and for outputting the result of the modeling as a component definition information 17, and a process generating part 20 for generating a component (Enterprise Bean instance) on the basis of the component definition information 17 which is outputted from the process constructing part 10. The process constructing part 10 and the process generating part 20 can be realized as program modules executed on a conventional computer, as stated later, and are connected to an input/output device 18, which includes a mouse, a keyboard, a display and so forth.

The process elements used for constructing the component comprise three kinds of process elements, i.e., basic process elements, custom process elements and execution sequence elements. Each of the basic process elements is an element in which each of basic processes for realizing a process of a component is separately implemented. Each of the custom process elements is an element in which each of separate processes related to processes for the basic process element (business conditions to be satisfied, or relatively small process invoked under certain conditions, by the basic process elements) is separately implemented independently of the basic process elements. Each of the custom process elements is implemented so as to be called from the basic process element which forms the basis thereof. The execution sequence elements are designed to connect the respective basic process elements to each other to form an execution route.

The process constructing part 10 has a GUI (Graphical User Interface) part 11 for displaying a plurality of process elements on a tool screen as icons and for modeling a process of a component by connecting the icons. The process constructing part 10 also has a definition information storing part 16 for storing information, which relates to a declaration for the integration of the respective process elements as a result of the modeling and the relationship between the process elements, in a memory of a computer as a component definition information 17.

The GUI part 11 has an input/output control part 12 for inputting/outputting control signals, data and so forth from/to the input/output device 18. The GUI part 11 also has a basic process defining part 13, a custom process defining part 14 and an execution sequence defining part 15, which are connected to the input/output control part 12. The input/output control part 12 is designed to acquire an event, which is inputted from the input/output device 18 by operating the mouse, to deliver the event to any one of the basic process defining part 13, the custom process defining part 14 and the execution sequence defining part 15.

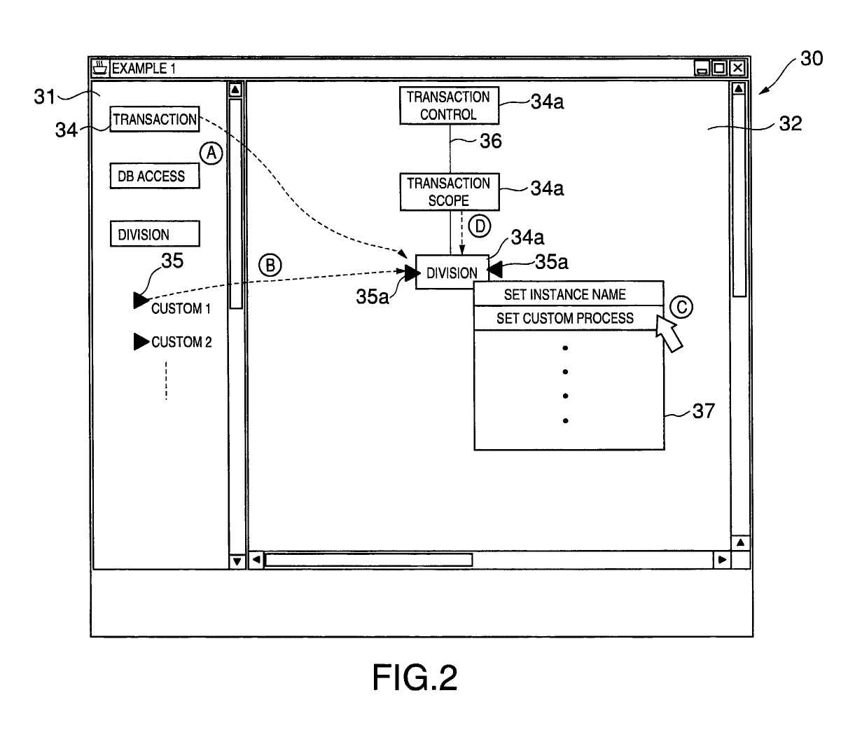

FIG. 2 is an illustration showing an example of a tool screen which is displayed by the GUI part 11. As shown in FIG. 2, the tool screen 30 has a pallet region 31 and a canvas region 32. In the pallet region 31, a plurality of icons 34 corresponding to the basic process elements (process elements for realizing basic processes, such as transaction, DB access, division and many other kinds of data processing), and a plurality of icons 35 corresponding to the custom process elements are arranged. In the canvas region 32, a plurality of icons 34aand 35aare placed on the basis of the icons 34 and 35 arranged in the pallet region 31. The icons 34aand 35aarranged in the canvas region 32 correspond to the instances of the basic process elements and custom process elements, which construct a component to be developed, respectively. In the pallet region 31 and canvas region 32, the basic process elements and the custom process elements are displayed as icons having different shapes. The execution sequence elements are displayed as lines (see reference number 36) which are drawn between the icons.

On such a tool screen 30, the user can carry out various operations (placing, movement, relating and duplication of icons, pop-up of a menu, and so forth) by means of the mouse which is included in the input/output device 18, and can model a process of a component as a tree structure by connecting the icons 34a, 34b and lines 36 in the canvas region 32.

Specifically, for example, the user can integrate a process for a basic process element into a process of a component by arranging the icon 34, which corresponds to the basic process element, as an icon 34ain the canvas region 32 by operating the mouse (see (A) in FIG. 2). In this case, the declaration for the integration of the basic process element is formed by the input/output control part 12 and basic process defining part 13.

In addition, the user can declare to integrate a separate process for a custom process element into a process for a basic process element by arranging the icon 35, which corresponds to the custom process element, as an icon 35ain the canvas region 32 by operating the mouse, such that the icon 35ais connected to the icon 34acorresponding to the basic process element, (see (B) in FIG. 2). In this case, the declaration for the integration of the custom process element is formed by the input/output control part 12 and custom process defining part 14. Furthermore, the integration of a custom process element can be also declared by using a pop-up dialog 37 of the icon 34acorresponding to a basic process element, into which the custom process element is to be integrated, by operating the mouse, and by inputting an identifier of the custom process element to a field of the popped-up dialog 37 (see (C) in FIG. 2).

Moreover, if the line 36 is drawn between the icons 34 corresponding to the basic process elements by operating the mouse (see (D) in FIG. 2), an execution sequence from a basic process element serving as a starting point to a basic process element serving as an end point can be formed by means of the input/output control part 12 and the execution sequence defining part 15.

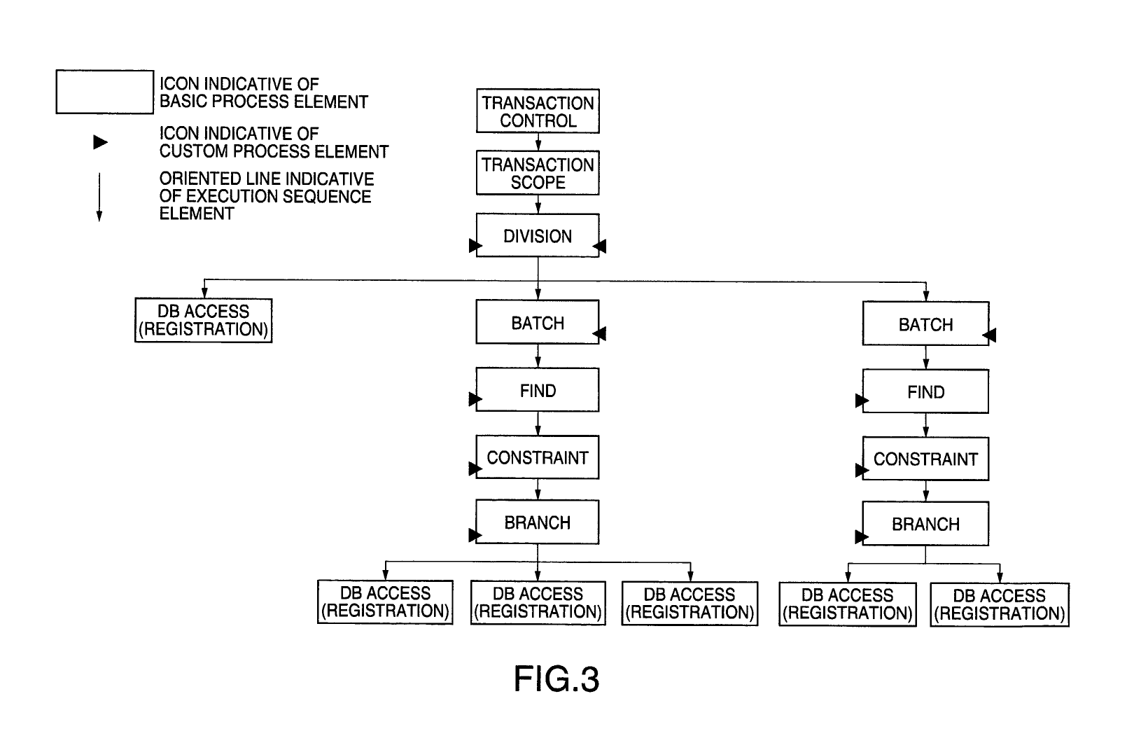

FIG. 3 is a block diagram showing an example of a process model for a component (Enterprise Bean) which is modeled on the tool screen 30.

Furthermore, information thus obtained, which relates to the declaration of the integration of the respective process elements and the relating between the respective process elements, is recorded in the memory of the computer as the component definition information 17. The component definition information 17 is also stored in a secondary storage at a user's request. The XML or the like can be used for recording the component definition information 17.

The process generating part 20 is constructed as a template Session Bean, and has a process model generating part (first generating part) 21 for generating an executable process model, which includes a plurality of process elements, in the memory of the computer on the basis of the component definition information 17 which is outputted from the process constructing part 10. The process generating part 20 also has an execution statement part (second generating part) 22 for generating a Session Bean instance (session instance) for calling the process model, which is generated by a process model generating part 21, via a predefined interface.

The process model generating part 21 is designed to automatically generate a program statement, which realizes a process of a component, on the basis of the component definition information 17 which is outputted from the process constructing part 10, and to sequentially execute the program statement to generate an executable process model in the memory of the computer. Specifically, information relating to basic process elements and custom process elements which is included in the component definition information 17 is converted into a statement for generating the instance of the corresponding process element. In addition, information relating to custom process elements is converted into a statement for causing a basic process element, which is connected thereto, to hold its reference. Moreover, information relating to an execution sequence element is converted into a statement for causing a basic process element, which corresponds to the starting point, to hold the reference of a basic process element which corresponds to the end point. Furthermore, when a component is executed, a process is carried out by the calling of a method based on this reference. If a process model is thus generated, a basic process element serving as the starting point of the basic process elements is called via a predefined interface of the Session Bean instance, so that the process model is executed.

Furthermore, the execution statement part 22 includes, in the interface for generating a predetermined Session Bean instance of the EJB, a statement for generating an executable process model by using the process model generating part 21. The execution statement part 22 also includes, in the interface of the Session Bean instance for executing the function of the component, a statement for calling an instance of a basic process element serving as the starting point of the generated process model, via a predefined interface.

With this construction, the operation of this preferred embodiment will be described below.

Modeling

Referring to FIGS. 1 and 2, a modeling process for a component (Enterprise Bean) will be described below.

If the user carries out any one of various operations for icons, which are displayed on the tool screen 30 by the GUI part 11 of the process constructing part 10, by means of the mouse or the like of the input/output device 18, an event inputted by operating the mouse is acquired by the input/output control part 12 of the GUI part 11 to be delivered to any one of the basic process defining part 13, the custom process defining part 14 and the execution sequence defining part 15. At this time, data of a predetermined format ({kind of event}) are delivered between the input/output control part 12 and any one of the basic process defining part 13, the custom process defining part 14 and the execution sequence defining part 15.

Therefore, in the basic process defining part 13, custom process defining part 14 or execution sequence defining part 14 to which the event have been delivered, a predetermined process based on the delivered event is carried out. Specifically, for example, the icon 34 corresponding to a basic process element is arranged in the canvas region 32 as the icon 34aby operating the mouse, the declaration that a process for the basic process element is integrated into a process of a component is formed in the basic process defining part 13. In addition, if the icon 35 corresponding to a custom process element is arranged as the icon 35aby operating the mouse so that the icon 35 is connected to the icon 34acorresponding to the basic process element in the canvas region 32, the declaration that a separate process for the custom process element is integrated into a process for the basic process element is formed in the custom process defining part 14. Moreover, if the line 36 is drawn between the icons 34acorresponding to the basic process element by operating the mouse, an execution sequence from a basic process element serving as the starting point to a basic process element serving as the end point is formed in the execution sequence defining part 15.

The results of the basic process defining part 13, the custom process defining part 14 and the execution sequence defining part 15 are recorded in the memory of the computer as the component definition information 17 by the definition information storing part 16 via the input/output control part 12. In this case, the format of the data delivered between the input/output control part 12 and the definition information storing part 16 is as follows.

In the case of recording from the basic process defining part 13:

{kind of basic process element, identifier, property value*}

In the case of recording from the custom process defining part 14:

{kind of custom process element, identifier, property value*, identifier of basic process element into which it is be integrated}

In the case of recording from the execution sequence defining part 15:

{identifier of basic process element serving as the starting point, identifier of basic process element serving as the end point}

If the above described operations for the icons are carried out on the tool screen 30 to connect the icons 34aand 35aand the line 36 in the canvas region 32, the process of the component can be modeled as a tree structure.

Generation

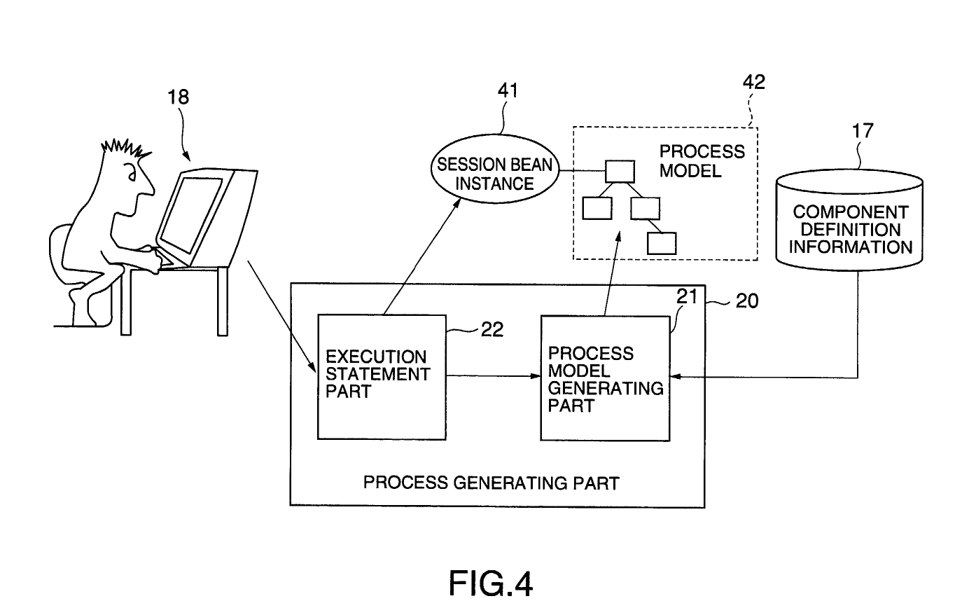

Referring to FIG. 4, a process for generating a component (Enterprise Bean instance) will be described below.

If the user generates a template Session Bean (process generating part 20) via a Home interface of the EJB Enterprise Bean by means of the input/output device 18, the execution statement part 22 of the process generating part 20 calls a predefined interface to make a request for the generation of an Enterprise Bean instance.

In accordance therewith, the Session Bean instance 41 is generated, and a request for generating the process model 42 is made to the process model generating part 21.

The process model generating part 21 automatically generates a program statement for realizing a process of a component, on the basis of the component defining information 17, and sequentially executes the program statement to generate an executable process model 42 in the memory of the computer. Furthermore, the Session Bean instance 41 includes a statement for calling an instance of a basic process element, which serves as the start point of the generated process model 42, among the instances of the process model 42, via a predefined interface, and the process model 42 is generated so as to be related to the Session Bean instance 41.

Execution of Function

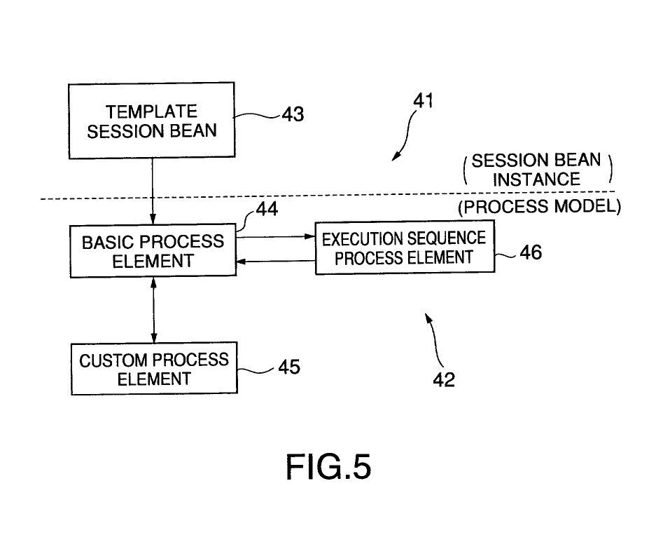

Referring to FIG. 5, a function executing process for the generated component (Enterprise Bean instance) will be described below.

The user makes a request for the execution of the function of the Session Bean instance 41 of the component (Enterprise Bean instance) generated as described above, by means of the input/output device 18, a specific instance of the Session Bean instance 41 is called, and a function executing process is carried out by the process model 42.

FIG. 5 is a block diagram for explaining a function executing process in a component (Enterprise Bean instance). In FIG. 5, the structure of a component (Enterprise Bean instance) is shown as the relationship between classes which will form the basis for basic process elements, custom process elements and execution sequence elements.

As shown in FIG. 5, a request for the execution of a function is delivered from the Session Bean instance 41 (template Session Bean 43) to a basic process element 44 serving as the starting point of the process model 42.

In the basic process element 44, it is checked at a predetermined place during a process whether a custom process element 45 has been added thereto. If the custom process element 45 has been added, the added custom process element 45 is called via a predefined interface. It is noted that the generation order of the custom process element 45 and execution sequence element 46 is the following: the custom process element 45 (pre-custom process), the execution sequence element 46 and the custom process element 45 (post-custom process). In the basic process element 44, it is checked at a predetermined place during a process whether the execution sequence element 46 has been added. If the execution sequence element 46 has been added, the added execution sequence element 46 is called via a predefined interface. In the execution process element 46, a specific basic process element 44 to be executed next is assigned, and the assigned basic process element 44 is called via a predefined interface.

It is noted that the process in the custom process element 45 or the execution sequence element 46 is completed to return to the basic process element 44 again, the remaining process in the basic process element 44 is carried out.

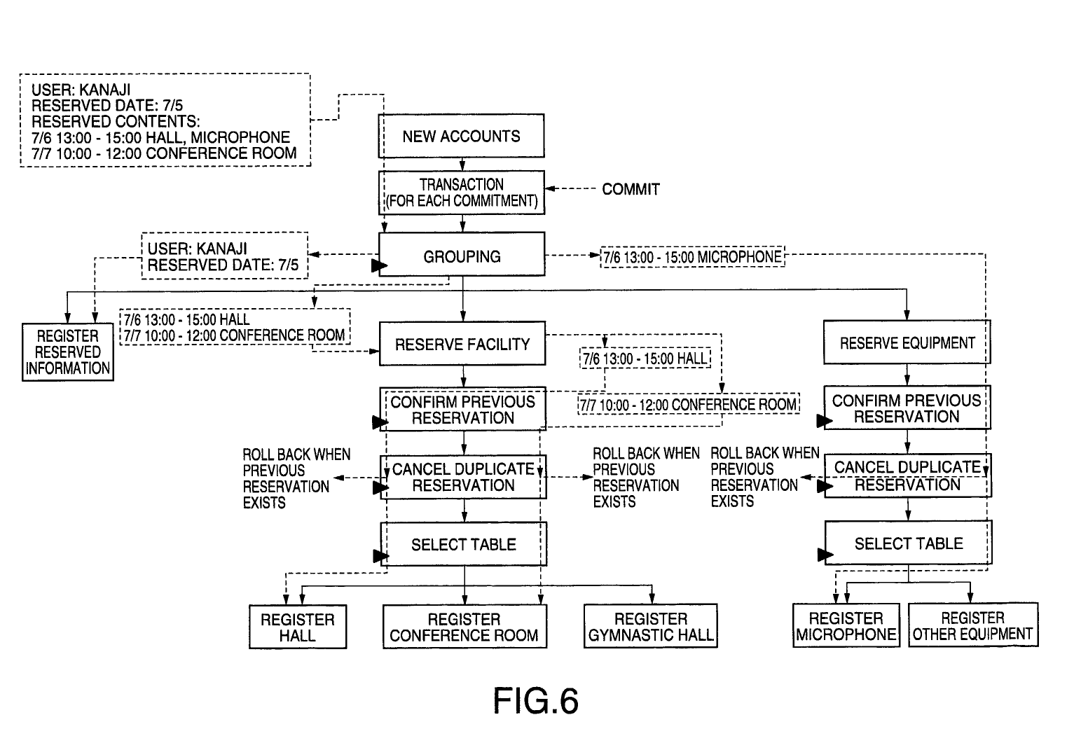

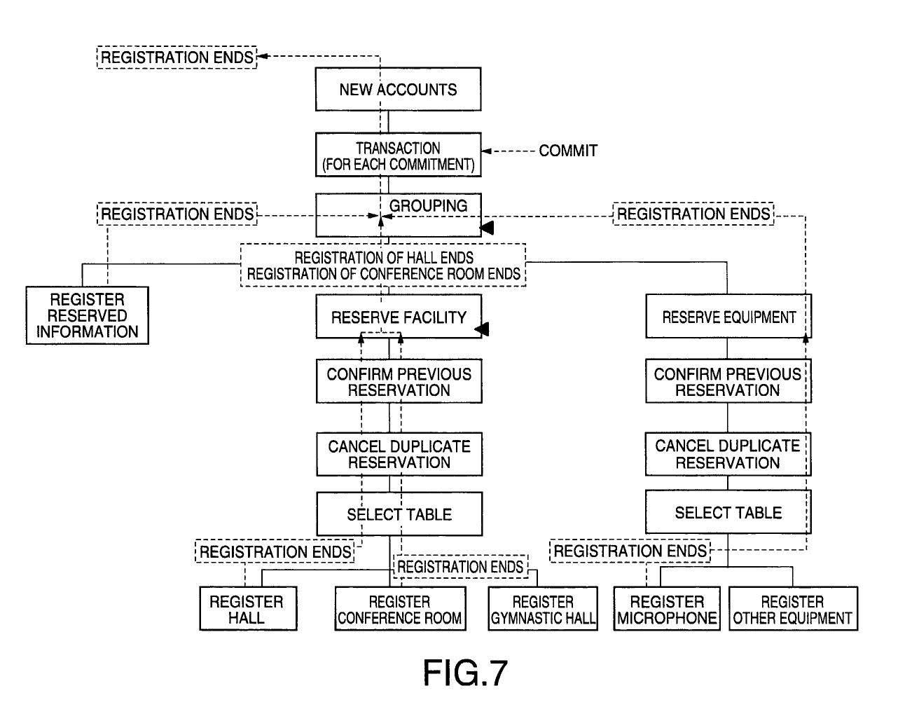

FIGS. 6 and 7 are diagrams specifically showing the flow of a process in a component (Enterprise Bean instance). FIG. 6 shows a state of an approach route in which instructions and data are propagated to the end via a tree structure in a process model for a facility reserving system. FIG. 7 shows a state of a return route in the process model shown in FIG. 6. It is noted that FIGS. 6 and 7 are described in accordance with the same notation as that in the process model shown in FIG. 3. The structure of the process model is shown as the relationship between the respective instances of the basic process element, custom process element and execution sequence element. As shown in FIGS. 6 and 7, the calling of interfaces is repeated between the basic process element and the execution sequence element, so that instructions and data are sequentially propagated to carry out the function executing process of the component (Enterprise Bean instance).

Thus, according to this preferred embodiment the process elements (the basic process element and the custom process element) are displayed on the tool screen 30 as the icons, and the execution sequence between these process elements is displayed as the oriented line, so that the process of the component (Enterprise Bean) can be visually modeled. In addition, on the basis of such modeling, the executable process model 41 and the Session Bean instance 42 for calling the process model 42 via the predefined interface are generated, so that the component can be directly generated and executed without particularly carrying out any additional implementation works to the modeled Enterprise Bean. Therefore, the development of Enterprise Bean, which will form the basis for the development of an application, and the integration of the Enterprise Bean into the intermediate layer of the server can be efficiently carried out without deeply entering into the implementation side of the Enterprise Bean.

While the execution sequence element separated from the basic process element has been provided in the above described preferred embodiment, the basic process element may directly call another basic process element via an interface.

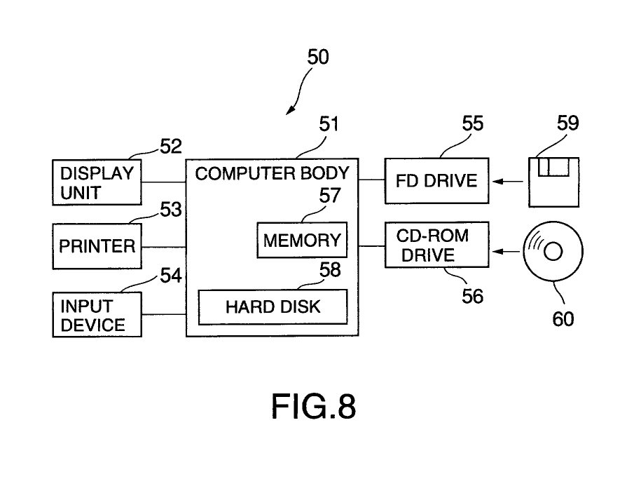

In the above described preferred embodiment, any one of the process constructing part 10 and the process generating part 20 can be realized as program modules executed in a computer system 50 as shown in FIG. 8. In addition, a framework for a business process development, which includes a class library of process elements (basic process element, custom process element and execution sequence element) and so forth, can be also installed in the computer system 50 as shown in FIG. 8. The computer system 50 comprises various peripheral devices, which include a display unit 52, such as a CRT; a printer 53; an input device 54, such as a keyboard and a mouse; a FD drive 55; a CD-ROM drive 56; and a hard disk drive 58, together with a computer body 51. The program including the above described program modules is stored in a memory 57 or a hard disk 58 in the computer body 51, or in a computer-readable recording medium, such as a flexible disk 59 or a CD-ROM 60, and can sequentially read out of the CPU (Central Processing Unit) of the computer body 51 to realize the above described function.

The recording media according to the present invention should not be limited to flexible disks and CD-ROMs. The recording media may be any recording media, which are capable of recording programs and which are capable of being read by computers, such as magnetic disks, internal memories, optical disks (CD-R, DVD (Digital Versatile Disk), etc.), optical magnetic disks (MO (Magneto Optical), etc.) and semiconductor memories, and their recording types may be any types. In addition, the recording media include carrier waves, which are transmitted on a network, and information transmitting media.

A part of each processing for realizing this preferred embodiment may be executed by an operating system (OS), which operates on a computer on the basis of the instruction of a program installed in the computer from a recording medium, or a middle ware (MW), such as a data base management software or a network software.

The recording media according to the present invention should not be limited to media independent of computers, and includes a medium in which a program transmitted by LAN or Internet has been downloaded to be stored or temporarily stored.

The number of the recording media according to the present invention should not be limited to one. The processing in this preferred embodiment may be executed by a plurality of media, and the construction of the media may be any construction.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments, which can be embodied without departing from the principle of the invention as set forth in the appended claims.

What is claimed is:

1. A component development supporting system for developing a component, which will form a basis for development of an application, by connecting a plurality of process elements, said component development supporting system comprising:
a process constructing part that models a process of a component by connecting a plurality of process elements and outputs a result of modeling as a component definition information; and
a process generating part that generates a component on the basis of said component definition information which is outputted from said process constructing part, said process generating part having (i) a first generating part for generating an executable process model, which includes a plurality of process elements, on the basis of said component definition information, and (ii) a second generating part for generating a session instance for calling the process model which is generated by the first generating part, via a predefined interface.

2. A component development supporting system as set forth in claim 1, wherein said plurality of process elements include a plurality of basic process elements in which each of basic processes for realizing a process of said component has been implemented, and a plurality of custom process elements in which each of separate processes related to the basic process element has been implemented.

3. A component development supporting system as set forth in claim 2, wherein said plurality of process elements further include a plurality of execution sequence elements for forming an execution route to connect said basic process elements to each other.

4. A component development supporting system as set forth in claim 1, wherein said process constructing part displays said plurality of process elements as icons to enable a user to model a process of a component by connecting the icons.

5. A component development supporting method for developing a component, which will form a basis for development of an application, by connecting a plurality of process elements, said component development supporting method comprising the steps of:
modeling a process of a component by connecting a plurality of process elements, to output a result of modeling as a component definition information;
generating an executable process model, which includes a plurality of process elements, on the basis of the outputted component definition information; and
generating a session instance for calling the generated process model via a predefined interface.

6. A component development supporting method as set forth in claim 5, wherein said plurality of process elements include a plurality of basic process elements in which each of basic processes for realizing a process of said component has been implemented, and a plurality of custom process elements in which each of separate processes related to the basic process element has been implemented.

7. A component development supporting method as set forth in claim 6, wherein said plurality of process elements further include a plurality of execution sequence elements for forming an execution route to connect said basic process elements to each other.

8. A component development supporting method as set forth in claim 5, wherein, in the step of modeling, said plurality of process elements are displayed as icons to enable a user to model a process of a component by connecting the icons.

9. A computer-readable recording medium having stored a component development supporting program for developing a component, which will form a basis for development of an application, by connecting a plurality of process elements, said component development supporting program causing a computer to execute the procedures of:
modeling a process of a component by connecting a plurality of process elements, to output a result of modeling as a component definition information;
generating an executable process model, which includes a plurality of process elements, on the basis of the outputted component definition information; and
generating a session instance for calling the generated process model via a predefined interface.

10. A computer-readable recording medium having stored a component development supporting program for developing a component, as set forth in claim 9, wherein said plurality of process elements include a plurality of basic process elements in which each of basic processes for realizing a process of said component has been implemented, and a plurality of custom process elements in which each of separate processes related to the basic process element has been implemented.

11. A computer-readable recording medium having stored a component development supporting program for developing a component, as set forth in claim 10, wherein said plurality of process elements further include a plurality of execution sequence elements for forming an execution route to connect said basic process elements to each other.

12. A computer-readable recording medium having stored a component development supporting program for developing a component, as set forth in claim 9, wherein, in the procedure of modeling, said plurality of process elements are displayed as icons to enable a user to model a process of a component by connecting the icons.
